(19) United States
(12) Patent Application Publication
(10) Pub. No.: US 2026/0255041 A1
(43) Pub. Date: Aug. 27, 2026

(54) IMAGE PICKUP MODULE, METHOD FOR MANUFACTURING IMAGE PICKUP MODULE, AND IMAGING DEVICE

(71) Applicant: CANON KABUSHIKI KAISHA, Tokyo (JP)

(72) Inventor: TAKAHIRO FURUYA, Kanagawa (JP)

(21) Appl. No.: 19/547,445

(22) Filed: Feb. 23, 2026

(30) Foreign Application Priority Data
Feb. 25, 2025 (JP) 2025-028261

(51) Int. Cl. H04N 23/55; G02B 27/12; H04N 23/52; H04N 23/90

(52) U.S. Cl. CPC H04N 23/55; G02B 27/126; H04N 23/52; H04N 23/90

(57) ABSTRACT

An image pickup module includes: a color separation prism that separates incident light into light beams and includes emission surfaces configured to emit the light beams in different directions; and image pickup elements provided corresponding to the emission surfaces. The image pickup element includes a facing surface facing the emission surface and including an image pickup region and an outer peripheral region outside the image pickup region, and the image pickup element is fixed to the color separation prism with an adhesive interposed between the outer peripheral region and the emission surface. At least one of the emission surfaces includes a distance increasing portion that faces the outer peripheral region and is formed such that a facing distance from the distance increasing portion to the outer peripheral region is greater than a facing distance from the at least one of the emission surfaces to the image pickup region.

### BACKGROUND

### Field of the Technology

The present disclosure relates to an image pickup module used in an imaging device.

### Description of the Related Art

In an image pickup module provided in an imaging device such as a camera, it is sometimes necessary to precisely fix an electronic component, such as an image pickup element, to an optical component such as a color separation prism. In a color camera including a multiple-plate image pickup module, a plurality of image pickup elements is provided for respective color components. Imaging light is separated into a plurality of color components through a color separation prism, and image outputs obtained by inputting the subject images of the respective color components to the image pickup elements are synthesized, so that a color video signal is formed and output. In such an image pickup module using a plurality of image pickup elements, subject images captured for the respective color components by the image pickup elements should be superimposed in six directions, i.e., with six degrees of freedom. The six directions are the optical axis direction, the direction of inclination with respect to the optical axis, and four directions associated with parallel and rotational movements in a plane perpendicular to the optical axis. Such a 6-axis adjustment is required to be made with extremely high accuracy. Specifically, alignment should be carried out with accuracy of the order of micrometers (μm).

Furthermore, in a method, the distance (air gap) between a color separation prism and an image pickup element is adjusted according to variations in the optical path length of each of the color separation prism and the image pickup element when aligning the image pickup element with respect to the color separation prism. When the color separation prism and the image pickup element are directly fixed to each other with an adhesive or the like in this method, a problem may arise due to the air gap. That is, since the air gap changes according to variations in the optical path length of each of the color separation prism and the image pickup element, there is a concern that when a certain amount of adhesive is applied to the air gap, the adhesive may not reach one of the members or the adhesive may overflow into the imaging area. As a countermeasure against this problem, a method of indirectly fixing the color separation prism and the image pickup element with a fixing member to control the thickness of the adhesive constant without being affected by a change of the air gap (Japanese Patent Application Publication No. H11-101934). This can prevent the adhesive from not reaching one of the members and from overflowing into the imaging area of the image pickup element.

However, if the structure using the fixing member in addition to the color separation prism and the image sensor is employed, there is a concern that the manufacturing man-hours may increase because of a larger number of parts and a larger number of bonding points. Furthermore, the color separation prism needs to be set larger than the image pickup element by the size of the fixing member, which may increase the size of the image pickup module.

### SUMMARY

The present disclosure is directed to improving an image pickup module in yield during production while avoiding upsizing of the image pickup module.

According to one aspect of the present disclosure, an image pickup module includes a color separation prism that is configured to separate incident light into a plurality of light beams corresponding to a plurality of color components and includes a plurality of emission surfaces configured to emit the plurality of light beams in different directions; and a plurality of image pickup elements that are provided corresponding to the plurality of emission surfaces and are configured to convert the plurality of light beams emitted from the plurality of emission surfaces into image pickup signals, wherein: each of the plurality of image pickup elements includes a facing surface facing a corresponding one of the plurality of emission surfaces in an optical axis direction of the light beam emitted from the corresponding one of the plurality of emission surfaces, the facing surface including an image pickup region and an outer peripheral region outside the image pickup region, and each of the plurality of image pickup elements is fixed to the color separation prism with an adhesive interposed between the outer peripheral region and the corresponding one of the plurality of emission surfaces; and at least one of the plurality of emission surfaces includes a distance increasing portion that faces the outer peripheral region of a corresponding one of the plurality of image pickup elements and is formed such that, in the optical axis direction, a facing distance from the distance increasing portion to the outer peripheral region is greater than a facing distance from the at least one of the plurality of emission surfaces to the image pickup region.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of a color camera including a three-plate image pickup module according to Example 1 of the present disclosure.

FIG. 2 is a right-side view of the image pickup module.

FIG. 3 is a front view of an image pickup element.

FIG. 4 is a plan view of the image pickup module.

FIG. 5 is a process drawing showing the manufacturing procedure of the image pickup module.

FIG. 6 is a configuration diagram of an apparatus for manufacturing the image pickup module.

FIG. 7 is a perspective view illustrating the bonding structure of the image pickup module.

FIG. 8 is a perspective view showing another configuration example of Example 1.

FIG. 9 is a perspective view showing another configuration example of Example 1.

FIG. 10 is a plan view showing a three-plate image pickup module according to Example 2 of the present disclosure.

FIG. 11 is a plan view showing another configuration example of Example 2.

FIG. 12 is a process drawing showing the manufacturing procedure of a three-plate image pickup module according to Example 3 of the present disclosure.

FIG. 13 is a configuration diagram showing an apparatus for manufacturing the three-plate image pickup module according to Example 3.

### DESCRIPTION OF THE EMBODIMENTS

With reference to the drawings below, embodiments for implementing the present disclosure will be described in detail by way of illustration on the basis of examples. However, it is to be understood that dimensions, materials, shapes, relative arrangements, and the like of components described in the embodiments are intended to be changed as deemed appropriate in accordance with configurations and various conditions of apparatuses to which the present disclosure is to be applied. That is, the scope of the present disclosure is not intended to be limited to the embodiments described below. Furthermore, although a plurality of features are described in the embodiments, all of the plurality of features are not necessarily essential to the invention of the present disclosure, and the plurality of features may be combined with one another as appropriate. Moreover, in the accompanying drawings, the same reference numeral will be assigned to the same or similar component and overlapping description will be omitted.

Note that in the following examples, a case where the image pickup module and the manufacturing method of the present disclosure are applied to a three-plate color camera, which is an example of a multiple-plate image pickup module, will be described, but the image pickup module to which the present disclosure is applicable is not limited to the examples described below. For example, the present disclosure can also be applied to the image pickup module of an endoscope camera provided in an endoscope device serving as an imaging device.

### Example 1

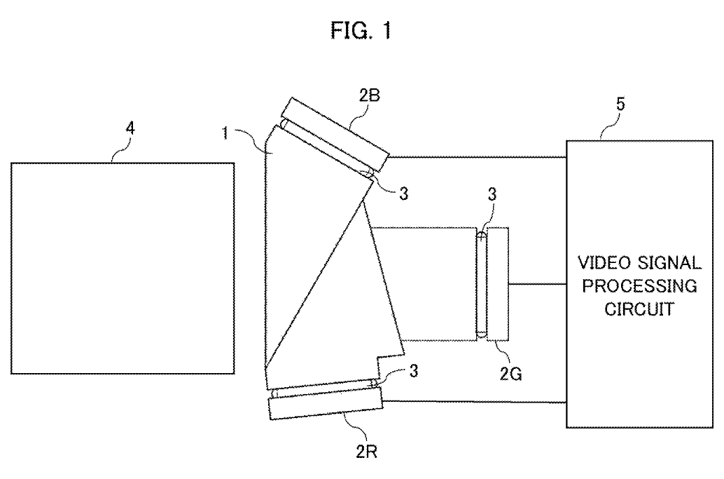

FIG. 1 is a schematic diagram showing the configuration of a color camera including a three-plate image pickup module according to Example 1 of the present disclosure. As shown in FIG. 1, the three-plate color camera includes an imaging lens 4, a three-plate image pickup module composed of a color separation prism 1 and three image pickup elements 2R, 2G, and 2B, and a video signal processing circuit 5. In the following description relating to the image pickup elements 2R, 2G, and 2B, the three image pickup elements 2R, 2G, and 2B may be collectively described as "image pickup element 2” unless the image pickup elements are separately described. Similarly, three emission surfaces 11r, 11g, and 11b of the after-mentioned color separation prism 1 may also be collectively described as “emission surface 11” unless the emission surfaces are separately described.

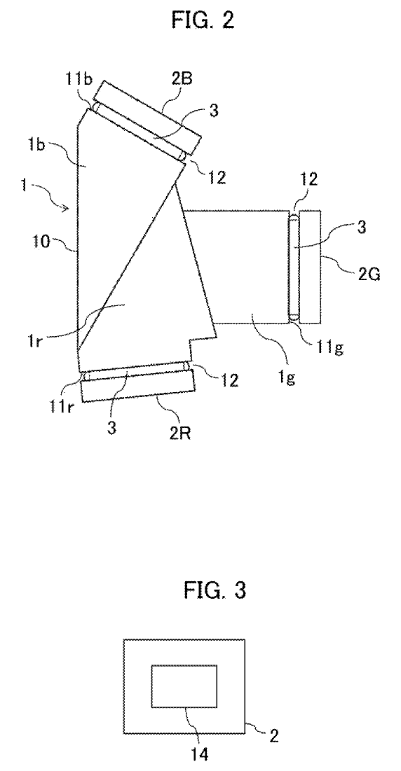

FIG. 2 is a right-side view of the three-plate image pickup module according to the present example. As shown in FIG. 2, the color separation prism 1 provided in the image pickup module according to the present example separates light incident from an entrance surface 10 into three primary-color RGB components, and is composed of three prism members 1r, 1g, and 1b. That is, in the color separation prism 1, light is separated into RGB components of three primary colors as a plurality of color components by the three prism members 1r, 1g and 1b, and the three kinds of separated light are emitted in different directions. The three image pickup elements 2R, 2G, and 2B are fixed to the respective emission surfaces 11r, 11g, and 11b of the three prism members 1r, 1g, and 1b with an adhesive 3. The three image pickup elements 2R, 2G, and 2B capture light emitted from the respective emission surfaces 11r, 11g, and 11b, convert the light into image pickup signals, output the images to the video signal processing circuit 5, and the video signal processing circuit 5 serving as a processing portion synthesizes the images of the respective colors to produce a color video signal.

The position of an image pickup element 2G is three-dimensionally adjusted (positioned) to obtain a desired image with respect to the color separation prism 1. In order to obtain a desired composite image with respect to the image pickup element 2G, the positions of an image pickup element 2R and an image pickup element 2B are three-dimensionally adjusted with an accuracy of at least half the pixel size or less. The position needs to be adjusted not only in a plane direction orthogonal to light incident on the image pickup element but also in the optical axis direction. When the optical axis direction is adjusted, variations in optical path lengths are adjusted (or absorbed) by air gaps 12 between the cover glass of the image pickup element 2 and the emission surfaces 11r, 11g and 11b. Variations in optical path length include variations in optical path length from the cover glasses to the imaging surfaces (an entrance surface that light enters on the image pickup element 2) of the image pickup elements 2 and variations in optical path length from the entrance surface 10 to the emission surfaces 11r, 11g, and 11b of the color separation prism 1.

FIG. 3 shows a front view of the image pickup element 2 and a schematic diagram of an entrance surface of the image pickup element 2 that is a facing surface of the image pickup element 2 facing the emission surface 11 of the color separation prism 1 in the optical axis direction of light emitted from the emission surface 11. The entrance surface of the image pickup element 2 is covered with a cover glass having the same size as the package, and an imaging area 14 as an image pickup region is narrower than the cover glass. The adhesive 3 is applied to an area outside the imaging area 14 (outer peripheral region). The air gaps 12 adjusted by variations in optical path length shown in FIG. 2 and other drawings are fixed with the adhesive 3 applied to the area outside the imaging area 14 of the image pickup element 2 shown in FIG. 3 (interposed between the emission surface 11 and the image pickup element 2). At this time, the amount of the adhesive 3 is set such that even if the air gap is large, the adhesive 3 is in contact with both the color separation prism 1 and the image pickup element 2, and even if the air gap is small, the adhesive 3 does not overflow into the imaging area 14 of the image pickup element 2.

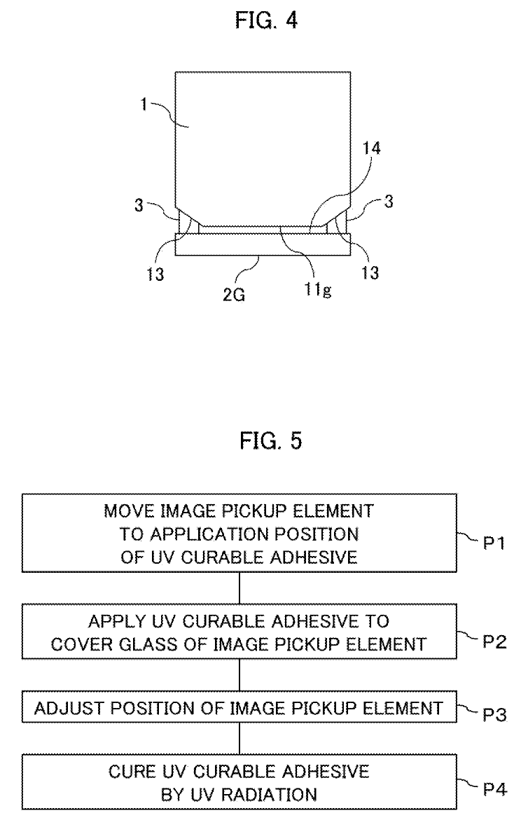

FIG. 4 is a schematic plan view of the three-plate image pickup module according to the present example. The emission surface 11 of the color separation prism 1 includes a first region facing the imaging area 14 (image pickup region) of the image pickup element 2 and a second region facing an area (outer peripheral region) outside the imaging area 14 of the image pickup element 2. The second region includes bonding portions 13. The bonding portion 13 is a portion bonded to the area (outer peripheral area) outside the imaging area 14 of the image pickup element 2 with the adhesive 3. The bonding portion 13 of the color separation prism 1 of the present example shown in FIG. 4 has an inclined shape. Specifically, the bonding portions 13 provided in the second region of the emission surface 11 are configured as inclined surfaces such that the facing distance from the area outside the imaging area 14 in the optical axis direction gradually increases with a distance from the first region in a first direction intersecting the optical axis direction. The first direction is assumed to be perpendicular to the optical axis direction in the present example. The first region of the emission surface 11 is a surface extending along the first direction, and the inclined surface of the bonding portion 13 is a surface extending along a second direction that is inclined with respect to both the optical axis direction and the first direction. The provision of the bonding portions 13 causes the facing distance between the emission surface 11 and the image pickup element 2 in the optical axis direction to locally increase at the bonding portions 13. That is, the facing distance from the bonding portions 13 of the second region of the emission surface 11 to the image pickup element 2 (outer peripheral region) in the optical axis direction is larger than the facing distance from the first region of the emission surface 11 to the image pickup element 2 (imaging area 14).

The inclined shape of the bonding portion 13 in the present example is an exemplary form of a distance increasing portion in which the coating region (priority region) of the adhesive 3 in the distance of the optical axis direction is extended wider than the air gap in the optical axis direction between the emission surface 11 and the imaging area 14 according to the feature of the present disclosure. FIG. 4 is a plan view showing, for explanation, the bonding portions 13 of the emission surface 11g of the G component. The emission surfaces 11r and 11b of the R and B components other than the G component also have similar shapes.

The inclination of the bonding portion 13 with respect to the emission surface 11 is not limited to 45º and is set to a proper angle according to the viscosity and bonding strength of the adhesive 3. If the adhesive 3 is cured by UV, the angle is determined in consideration of the transmissivity or the like of UV. When the angle is large with respect to the emission surface 11, the effect of suppressing the adhesive 3 overflowing into the imaging area 14 of the image pickup element 2 is enhanced, which is the effect of the present disclosure. However, it should be noted that the strength decreases due to a reduction in the cross-sectional area of the adhesive 3 and the bonding thickness varies depending on the place, resulting in a larger displacement due to shrinkage on curing.

In the configuration example shown in FIG. 4, the adhesive 3 is in contact with only the inclined bonding portion 13. It is important that the adhesive 3 does not reach the imaging area 14 of the image pickup element 2 (the adhesive 3 does not overlap the imaging area 14 in any region when viewed in the optical axis direction). Therefore, the image pickup module may be configured such that the adhesive 3 is in contact with the emission surface 11 other than the inclined bonding portions 13 in the range where the adhesive 3 does not reach the imaging area 14 of the image pickup element 2, or the adhesive 3 is in contact with the sides of the color separation prism 1 and the image pickup element 2.

Furthermore, by applying a water-repellent coating that repels the adhesive 3 to the imaging area 14 of the image pickup element 2, it can be expected to improve the effect of suppressing the intrusion of the adhesive 3 into the imaging area 14. The water-repellent coating that is water-repellent to the adhesive 3 may be applied not only to the imaging area 14 of the image pickup element 2 but also to the first region (the region facing the imaging area 14 of the image pickup element 2) of the emission surface 11 of the color separation prism 1.

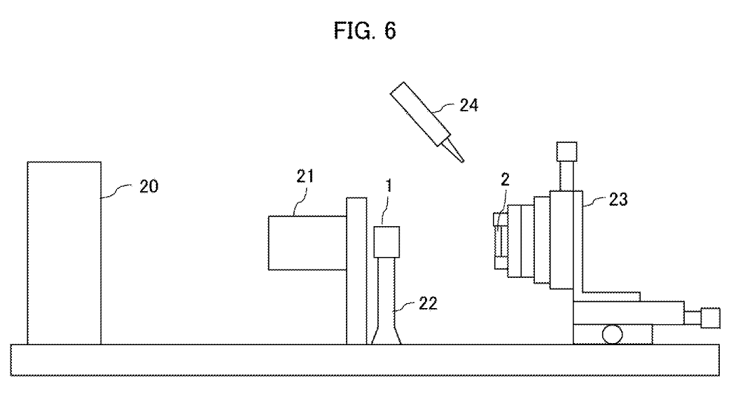

Referring to FIGS. 5 and 6, the manufacturing procedure of the image pickup module according to Example 1 will be described below. FIG. 5 is a process drawing showing the manufacturing procedure of the image pickup module. FIG. 6 is a schematic diagram showing the configuration of an apparatus for manufacturing the image pickup module according to Example 1. This manufacturing procedure will describe an example in which a UV curable adhesive is used as the adhesive 3.

First, the color separation prism 1 is fixed to a support base 22. The support base 22 is fixed in a predetermined positional relationship with an alignment chart 20 used for alignment and an imaging lens 21. Next, the image pickup element 2G is fixed to a six-axis manipulator (position adjusting device) 23. The image pickup element 2G is then moved to the application position of an application device 24 (P1). A predetermined amount of the adhesive 3 is applied to the image pickup element 2G using the application device 24 (P2). While confirming an image obtained from the image pickup element 2G, the position of the image pickup element 2G with respect to the color separation prism 1 is adjusted using the six-axis manipulator (position adjusting device) 23 such that the focus on the alignment chart 20 and the angle of view coincide with each other. The position adjustment brings the color separation prism 1 and the image pickup element 2G into contact with each other with the adhesive 3 (P3). In this state, the adhesive 3 is irradiated with UV light to be cured (P4).

Also on the image pickup elements 2R and 2B, the adhesive 3 is applied in the same process as on the image pickup element 2G. In the position adjustment of the image pickup elements 2R and 2B, however, the position is adjusted while confirming an image synthesized with the image of the image pickup element 2G such that the adjustment can be made with an accuracy of half the pixel size or less with respect to the image of the image pickup element 2G.

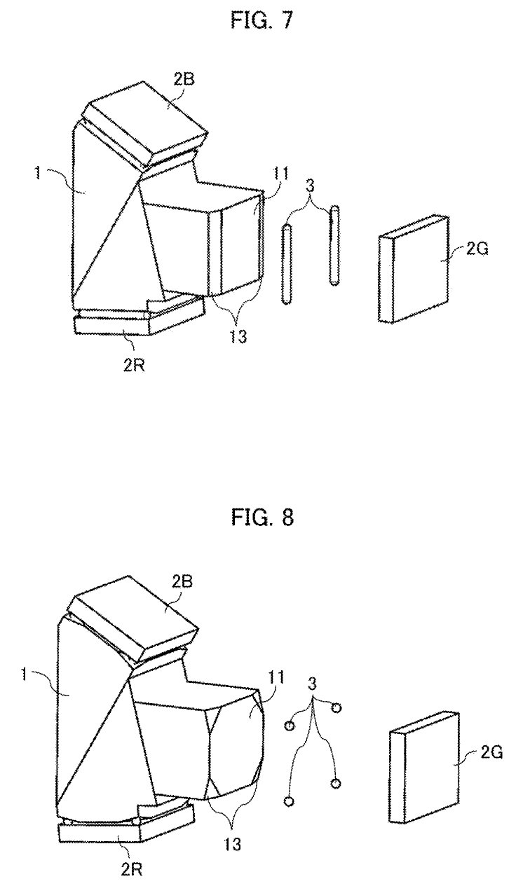

FIG. 7 is a perspective view showing the bonding structure of the image pickup element 2G of the three-plate image pickup module according to the present example. In the present example, the first region of the emission surface 11 is a rectangular region, and the bonding portions 13, which are inclined surfaces provided in the second region of the emission surface 11, are provided outside two parallel sides included in the outline of the first region, and the adhesive 3 is applied along the two sides. FIGS. 4 and 7 show a structure including the bonding portions 13 provided only on the two sides of the color separation prism 1, as a configuration example of the distance increasing portion that is a feature of the present disclosure. The configuration of the bonding portions 13 as a distance increasing portion is not limited thereto.

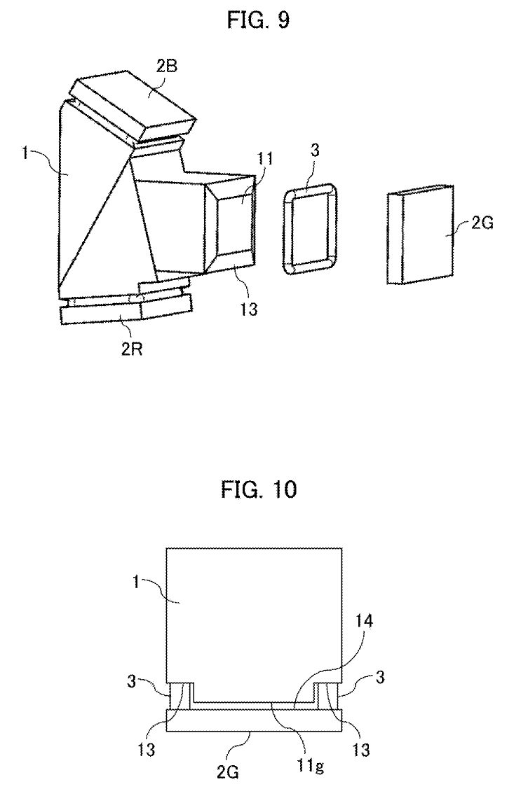

FIG. 8 is a perspective view showing a bonding structure when four corners of the emission surface 11 of the color separation prism 1 serve as the bonding portions 13, as another configuration example of Example 1. FIG. 9 is a perspective view showing a bonding structure when the outer peripheral portion of the emission surface 11 of the color separation prism 1 serves as the bonding portions 13, as another configuration example of Example 1. The bonding portions 13 provided for the color separation prism 1 may be applied to the four corners of the emission surface 11 as shown in FIG. 8, or may be applied to the outer periphery of the emission surface 11 as shown in FIG. 9. In other words, in the configuration example shown in FIG. 8, the emission surface 11 has a rectangular outline when viewed in the optical axis direction, and the bonding portions 13 are provided in regions corresponding to the four corners of the rectangular outline. Furthermore, in the configuration example shown in FIG. 9, the first region (the region facing the imaging area 14) of the emission surface 11 is rectangular, the second region (the region facing the area outside the imaging area 14) is formed around the outer periphery of the first region, and the bonding portions 13 are provided over the second region. As shown in FIG. 8, when the bonding portions 13 are applied only to the four corners of the emission surface 11, the amount of the adhesive 3 required for bonding and fixing the color separation prism 1 and the image pickup element 2 is reduced, thereby reducing the risk of spreading the adhesive 3 and shortening the coating and curing processes. As shown in FIG. 9, when the bonding portion 13 is applied to the entire outer periphery of the emission surface 11, a sufficient bonding area can be secured and the bonding strength can be further increased. In addition, dust and the like can be prevented from entering the imaging area 14.

The present example is configured such that the bonding portions 13 are inclined surfaces provided as distance increasing portions on the respective emission surfaces 11r, 11g, and 11b. The bonding portion 13 as an inclined surface may be provided on at least one of the emission surfaces 11r, 11g, and 11b.

Also, the form of the bonding portion 13 serving as the distance increasing portion may be a combination of the configuration examples shown in FIGS. 7 to 9. For example, a composite form may be employed such that a part of the bonding portion 13 shown in FIG. 7 is applied to a part of the second region of the emission surface 11 and a part of the bonding portion 13 shown in FIGS. 8 and 9 is applied to the other part.

According to the present example, when the color separation prism 1 and the image pickup element 2 are fixed to each other with an adhesive or the like, the color separation prism 1 and the image pickup element 2 can be stably bonded to each other without using any fixing member as in the prior art. That is, even if the distance between the color separation prism 1 and the image pickup element 2 changes according to variations in the optical path lengths of the color separation prism 1 and the image pickup element 2, it is possible to prevent the adhesive 3 from not reaching one of the members and from overflowing into the imaging area 14 of the image pickup element 2. Therefore, according to the present example, the yield can be improved during production while avoiding upsizing of the image pickup module.

### Example 2

FIG. 10 is a schematic plan view showing a three-plate image pickup module according to Example 2 of the present disclosure. For convenience of explanation, members having the same functions as those described in Example 1 are indicated by the same reference numerals, and the description thereof is omitted. FIG. 10 is a plan view showing, for explanation, bonding portions 13 of an emission surface 11g of a G component. Exit surfaces 11r and 11b of R and B components other than the G component also have similar shapes.

The bonding portion 13 of the color separation prism 1 according to Example 1 has an inclined shape, whereas the bonding portion 13 of the color separation prism 1 according to the present example shown in FIG. 10 is configured as a step portion that is recessed in the optical axis direction with respect to the emission surface 11 of the color separation prism 1. Even if the step causes adhesive 3 to be flattened by a change of air gaps 12 due to the positioning of an image pickup element 2, the effect of suppressing overflowing into an imaging area 14 can be expected. In this structure, a difference in bonding thickness between places is smaller than that of Example 1, thereby obtaining the effect of suppressing the intrusion of the adhesive 3 into the imaging area 14 while suppressing a displacement of shrinkage on curing. The effect of suppressing the intrusion of the adhesive 3 into the imaging area 14 is enhanced as the step increases in size. It should be noted that the bonding strength may decrease and the reach of the adhesive 3 may be interrupted unless the height of the adhesive 3 is equal to or larger than a certain amount.

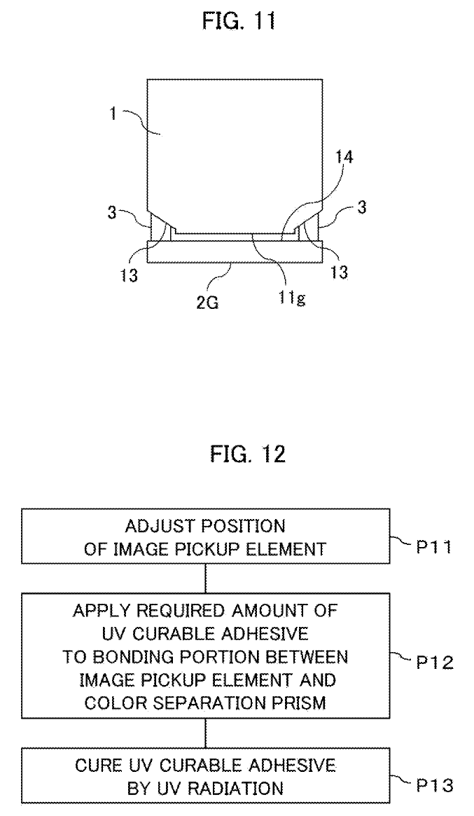

Furthermore, FIG. 11 shows, as another example of Example 2, a plan view of a three-plate image pickup module in which the bonding portion 13 has a step and is inclined with respect to an emission surface 11. FIG. 11 is a plan view showing, for explanation, the bonding portions 13 of the emission surface 11g of the G component. The emission surfaces 11r and 11b of the R and B components other than the G component also have similar shapes. Also in this structure, the steps of the bonding portions 13 suppress the intrusion of the adhesive 3 into the imaging area 14, and the effect of the inclination can be expected such that the adhesive 3 is pressed to the opposite side of the imaging area 14. With this structure, both the effect of the inclined shape of the bonding portion 13 according to Example 1 and the effect of the stepped shape of Example 2 shown in FIG. 10 can be expected.

In FIGS. 10 and 11, the adhesive 3 is in contact with only the inclined bonding portion 13. It is important that the adhesive 3 does not reach the imaging area 14 of the image pickup element 2. Therefore, the image pickup module may be configured such that the adhesive 3 is in contact with the emission surface 11 other than the inclined bonding portions 13 in the range where the adhesive 3 does not reach the imaging area 14 of the image pickup element 2, or the adhesive 3 is in contact with the sides of the color separation prism 1 and the image pickup element 2.

Also in Example 2, the manufacturing procedure can be executed according to the process drawing of FIG. 5 like the manufacturing procedure of Example 1, and the details thereof are omitted.

FIGS. 10 and 11 show a structure in which the bonding portions 13 are provided on only two sides of the color separation prism 1. Also in Example 2, the bonding portions 13 may be applied to the four corners of the emission surface 11 or may be applied to the outer periphery of the emission surface 11. The effect is the same as that of Example 1, and the details thereof are omitted.

### Example 3

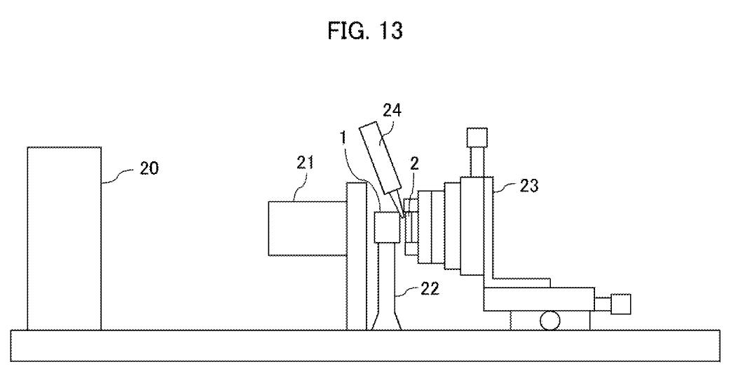

Referring to FIGS. 12 and 13, the manufacturing procedure of a method for manufacturing an image pickup module according to Example 3 of the present disclosure will be described below. FIG. 12 is a process drawing. FIG. 13 is a configuration diagram of a manufacturing apparatus. For convenience of explanation, members having the same functions as those described in Example 1 are indicated by the same reference numerals, and the description thereof is omitted.

In the method described in the manufacturing procedures of Examples 1 and 2, a fixed amount of adhesive 3 is applied to an image pickup element 2, and then the adhesive 3 is brought into contact with a color separation prism 1. Example 3 describes a method of applying a necessary amount of the adhesive 3 laterally (from the side) after the position of the image pickup element 2 is adjusted with respect to the color separation prism 1.

First, the color separation prism 1 is fixed to a support base 22. The support base 22 is fixed in a predetermined positional relationship with an alignment chart 20 used for alignment and an imaging lens 21. An image pickup element 2G is fixed to a six-axis manipulator (position adjusting device) 23. While confirming an image obtained from the image pickup element 2G, the position of the image pickup element 2G is adjusted to set focus on the alignment chart 20 (P11).

In a state in which the position of the image pickup element 2G is adjusted (positioned) with respect to the color separation prism 1, a required amount of the adhesive 3 is applied to the bonding portion 13 by an application device 24 laterally in a direction intersecting the optical axis with respect to a space where the emission surface 11 and the image pickup element 2 face each other (P12). At this time, it is preferable to determine air gaps 12 after the position adjustment and apply the adhesive after calculating the amount of the adhesive so as to prevent the intrusion of the adhesive into the imaging area 14. A method of adjusting the amount of coating while confirming the clearance between the imaging area 14 and the adhesive 3 may be adopted.

In a state in which the color separation prism 1 and the image pickup element 2 are fixed together and the adhesive 3 is applied, the adhesive 3 is cured by UV radiation (P13).

Also in image pickup elements 2R and 2B, bonding is performed in the same process as that of the image pickup element 2G. In the position adjustment of the image pickup elements 2R and 2B, however, the position is adjusted while confirming an image synthesized with the image of the image pickup element 2G such that the adjustment can be made with an accuracy of half the pixel size or less with respect to the image of the image pickup element 2G.

The structure of the image pickup module according to the present example is a structure in which the adhesive 3 is easily applied laterally after the position adjustment. Manufacturing according to this procedure can shorten the step of moving the image pickup element 2 to the adhesive application position. In addition, even if variations in the optical path lengths of the color separation prism 1 and the image pickup element 2 increase, it is possible to adjust the application amount of the adhesive 3 according to the air gaps 12 resulting from the variations. Thus, it is expected that the intrusion of the adhesive 3 into the imaging area 14 can be suppressed.

In the description of the examples, the image pickup module and the manufacturing method according to the present disclosure are applied to a three-plate color camera. The present disclosure may be applied to multiple-plate types such as a two-plate type or a four-plate type. For convenience of explanation, in the examples described above, the color separation prism 1 separates light into RGB components as a plurality of color components. The components are not limited to the RGB components. The present disclosure may be applied to prisms that split light into visible light, near infrared light, dual green, and the like.

The configurations of the examples can be combined with one another.

The present disclosure serves to improve an image pickup module in yield during production while avoiding upsizing of the image pickup module.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-028261, filed February 25, 2025, which is hereby incorporated by reference herein in its entirety.

What is claimed is:

1. An image pickup module comprising:
a color separation prism that is configured to separate incident light into a plurality of light beams corresponding to a plurality of color components and includes a plurality of emission surfaces configured to emit the plurality of light beams in different directions; and
a plurality of image pickup elements that are provided corresponding to the plurality of emission surfaces and are configured to convert the plurality of light beams emitted from the plurality of emission surfaces into image pickup signals,
wherein:
each of the plurality of image pickup elements includes a facing surface facing a corresponding one of the plurality of emission surfaces in an optical axis direction of the light beam emitted from the corresponding one of the plurality of emission surfaces, the facing surface including an image pickup region and an outer peripheral region outside the image pickup region, and each of the plurality of image pickup elements is fixed to the color separation prism with an adhesive interposed between the outer peripheral region and the corresponding one of the plurality of emission surfaces; and
at least one of the plurality of emission surfaces includes a distance increasing portion that faces the outer peripheral region of a corresponding one of the plurality of image pickup elements and is formed such that, in the optical axis direction, a facing distance from the distance increasing portion to the outer peripheral region is greater than a facing distance from the at least one of the plurality of emission surfaces to the image pickup region.

2. The image pickup module according to claim 1, wherein:
each of the plurality of emission surfaces includes a first region facing the image pickup region of the corresponding one of the plurality of image pickup elements in the optical axis direction and a second region facing the outer peripheral region of the corresponding one of the plurality of image pickup elements in the optical axis direction; and
the distance increasing portion includes an inclined surface that is inclined with respect to the first region such that a facing distance between the second region and the outer peripheral region in the optical axis direction gradually increases with increase in distance from the first region in a direction intersecting the optical axis direction.

3. The image pickup module according to claim 2, wherein:
the first region is a surface extending in a first direction intersecting the optical axis direction; and
the inclined surface is a surface extending in a second direction inclined with respect to the optical axis direction and the first direction.

4. The image pickup module according to claim 3, wherein:
the first region is a rectangular region; and
the distance increasing portion includes a plurality of the inclined surfaces disposed outside each of two parallel sides included in an outline of the first region.

5. The image pickup module according to claim 3, wherein:
each of the plurality of emission surfaces has a rectangular outline when viewed in the optical axis direction; and
the distance increasing portion includes a plurality of the inclined surfaces disposed in regions corresponding to four corners of the rectangular outline.

6. The image pickup module according to claim 3, wherein
the inclined surface surrounds an outer periphery of the first region.

7. The image pickup module according to claim 6, wherein
the first region is a rectangular region.

8. The image pickup module according to claim 1, wherein
each of the plurality of emission surfaces includes a first region facing the image pickup region of the corresponding one of the plurality of image pickup elements in the optical axis direction; and
the distance increasing portion is a step portion that is recessed in the optical axis direction with respect to the first region.

9. The image pickup module according to claim 1, wherein
the image pickup region of each of the plurality of image pickup elements is covered with a coating that is water-repellent to the adhesive.

10. The image pickup module according to claim 1, wherein
each of the plurality of emission surfaces includes a first region facing the image pickup region of the corresponding one of the plurality of image pickup elements in the optical axis direction; and
the first region of each of the plurality of emission surfaces is covered with a coating that is water-repellent to the adhesive.

11. A method for manufacturing an image pickup module, the image pickup module including: a color separation prism that is configured to separate incident light into a plurality of light beams corresponding to a plurality of color components and includes a plurality of emission surfaces configured to emit the plurality of light beams in different directions; and a plurality of image pickup elements that are provided corresponding to the plurality of emission surfaces and are configured to convert the plurality of light beams emitted from the plurality of emission surfaces into image pickup signals, wherein: each of the plurality of image pickup elements includes a facing surface facing a corresponding one of the plurality of emission surfaces in an optical axis direction of the light beam emitted from the corresponding one of the plurality of emission surfaces, the facing surface including an image pickup region and an outer peripheral region outside the image pickup region, and each of the plurality of image pickup elements is fixed to the color separation prism with an adhesive interposed between the outer peripheral region and the corresponding one of the plurality of emission surfaces; and
at least one of the plurality of emission surfaces includes a distance increasing portion that faces the outer peripheral region of a corresponding one of the plurality of image pickup elements and is formed such that, in the optical axis direction, a facing distance from the distance increasing portion to the outer peripheral region is greater than a facing distance from the at least one of the plurality of emission surfaces to the image pickup region, the method comprising:
positioning each of the plurality of image pickup elements with respect to the corresponding one of the plurality of emission surfaces; and
applying an adhesive to each of facing spaces between the plurality of emission surfaces and the plurality of image pickup elements, laterally in a direction intersecting the optical axis direction.

12. An imaging device comprising:
an image pickup module including:
a color separation prism that is configured to separate incident light into a plurality of light beams corresponding to a plurality of color components and includes a plurality of emission surfaces configured to emit the plurality of light beams in different directions;
a plurality of image pickup elements that are provided corresponding to the plurality of emission surfaces and are configured to convert the plurality of light beams emitted from the plurality of emission surfaces into image pickup signals,
wherein:
each of the plurality of image pickup elements includes a facing surface facing a corresponding one of the plurality of emission surfaces in an optical axis direction of the light beam emitted from the corresponding one of the plurality of emission surfaces, the facing surface including an image pickup region and an outer peripheral region outside the image pickup region, and each of the plurality of image pickup elements is fixed to the color separation prism with an adhesive interposed between the outer peripheral region and the corresponding one of the plurality of emission surfaces; and
at least one of the plurality of emission surfaces includes a distance increasing portion that faces the outer peripheral region of a corresponding one of the plurality of image pickup elements and is formed such that, in the optical axis direction, a facing distance from the distance increasing portion to the outer peripheral region is greater than a facing distance from the at least one of the plurality of emission surfaces to the image pickup region; and
a processing portion configured to output a video signal based on the image pickup signals output from the plurality of image pickup elements of the image pickup module.
